(19) United States
(12) Patent Application Publication
(10) Pub. No.: US 2025/0370497 A1
(43) Pub. Date: Dec. 4, 2025

(54) CHIPLET CLOCK FORWARDING ARCHITECTURE

(71) Applicant: ATI Technologies ULC, Markham (CA)

(72) Inventors: Ankit Joshi, Markham (CA); Tyrone Huang, Markham (CA); Tor L. Ekenberg, Markham (CA)

(73) Assignee: ATI Technologies ULC, Markham, ON (CA)

(21) Appl. No.: 18/680,368

(22) Filed: May 31, 2024

(51) Int. Cl. G06F 1/10; G06F 1/08

(52) U.S. Cl. CPC G06F 1/10; G06F 1/08

(57) ABSTRACT

The disclosed device includes a first die having a control circuit and a clock circuit, and at least a second die stacked over the first die. The control circuit forward data and a clock signal to the second die. The forwarded clock signal can be tuned by the second die independently from any clock distribution of the first die. Various other methods, systems, and computer-readable media are also disclosed.

### BACKGROUND

Certain die architectures, such as 2.5D or 3D architectures (e.g., chiplet/die stacking), allow various routing, packaging, and other performance benefits over generally planar architectures. Timing and coordination between components of the stacked dies can rely on a clock tree that is modified for the stacked die architecture. However, each die can exhibit different clock divergences.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for chiplet clock forwarding.

FIGS. 2A-J are a block diagrams of an exemplary stacked die architectures.

FIGS. 3A-C are block diagrams of exemplary clock forwarding chiplet architectures.

FIG. 4 is a flow diagram of an exemplary method for chiplet clock forwarding.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to clock forwarding for chiplets, such as chiplets in stacked dies. As will be explained in greater detail below, implementations of the present disclosure provide a first die using a first clock signal for synchronizing data circuits therein, and further forwarding a second clock signal to a second die stacked over the first die. By forwarding the second clock signal separately, the first die can send data to the second die based on the first clock signal while the second die can independently tune the second clock signal without relying on the same clock signal used by the first die. This independent clock tuning removes dependencies between chiplets/dies and advantageously minimizes or reduces clock divergence (e.g., clock timing uncertainties in receiving a same-sourced clock signal due to signal propagation delay and/or other differences in components). The architecture described herein further allows independent clock tuning without a significant impact on footprint.

In one implementation, a device for chiplet clock forwarding includes a first die comprising a control circuit, and a second die stacked over the first die. In some examples, the control circuit is configured to forward data to the second die based on a first clock signal, and forward a second clock signal to the second die.

In some examples, the second die further comprises a clock tuning circuit for tuning the second clock signal for a data circuit of the second die. In some examples, the clock tuning circuit tunes the second clock signal independently from the first clock signal.

In some examples, the control circuit receives the second clock signal directly from a clock circuit of the first die via an independent branch of a clock tree of the first die. In some examples, a branching point of the independent branch is closer to a root of the clock tree than the control circuit. In some examples, a branching point of the independent branch is closer to the control circuit than a root of the clock tree.

In some examples, the control circuit uses the first clock signal to synchronize with a data circuit of the first die. In some examples, the control circuit forwards the second clock signal using a through-silicon via (TSV).

In some examples, the device further includes a third die stacked over the second die, wherein the second die comprises a second control circuit configured to forward the second clock signal to the third die. In some examples, the third die further comprises a clock tuning circuit for tuning the second clock signal. In some examples, the clock tuning circuit tunes the second clock signal independently from the first die and the second die.

In one implementation, a system for chiplet clock forwarding includes a memory and a processor that includes a first die and a second die stacked over the first die. In some examples, the first die includes a clock circuit, a data circuit for holding data from the memory, and a control circuit that synchronizes with the data circuit based on a modified clock signal. In some examples, the control circuit is configured to forward data from the data circuit to the second die, and forward an unmodified clock signal from the clock circuit to the second die.

In some examples, the second die further comprises a clock tuning circuit for tuning the unmodified clock signal independently from the modified clock signal. In some examples, the control circuit receives the unmodified clock signal directly from the clock circuit of the first die via an independent branch of a clock tree of the first die. In some examples, a branching point of the independent branch is closer to a root of the clock tree than the control circuit. In some examples, a branching point of the independent branch is closer to the control circuit than a root of the clock tree.

In some examples, the processor further comprises a third die stacked over the second die. In some examples, the second die comprises a second control circuit configured to forward the unmodified clock signal to the third die. In some examples, the third die further comprises a clock tuning circuit for tuning the unmodified clock signal independently from the first die and the second die.

In one implementation, a method for chiplet clock forwarding includes (i) synchronizing a data circuit of a first die with a control circuit of the first die using a first clock signal, (ii) forwarding a second clock signal from a clock circuit of the first die to a clock tuning circuit of a second die stacked near the first die, and (iii) tuning the second clock signal with the clock tuning circuit independently of the first clock signal.

In some examples, the method includes forwarding the second clock signal to a second clock tuning circuit of a third die, and tuning the second clock signal with the second clock tuning circuit independently of the first die and the second die. In some examples, the second clock signal corresponds to an unmodified clock signal from a branch directly from the clock circuit.

Features from any of the implementations described herein can be used in combination with one another in accordance with the general principles described herein. These and other implementations, features, and advantages will be more fully understood upon reading the following detailed description in conjunction with the accompanying drawings and claims.

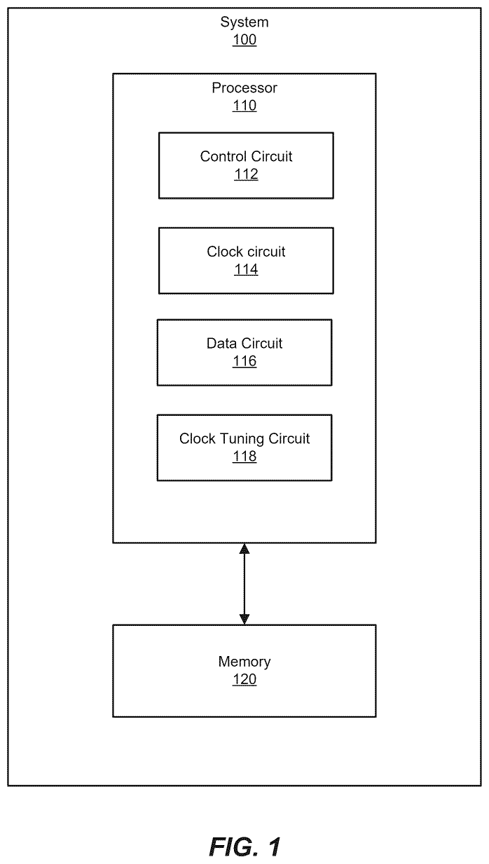

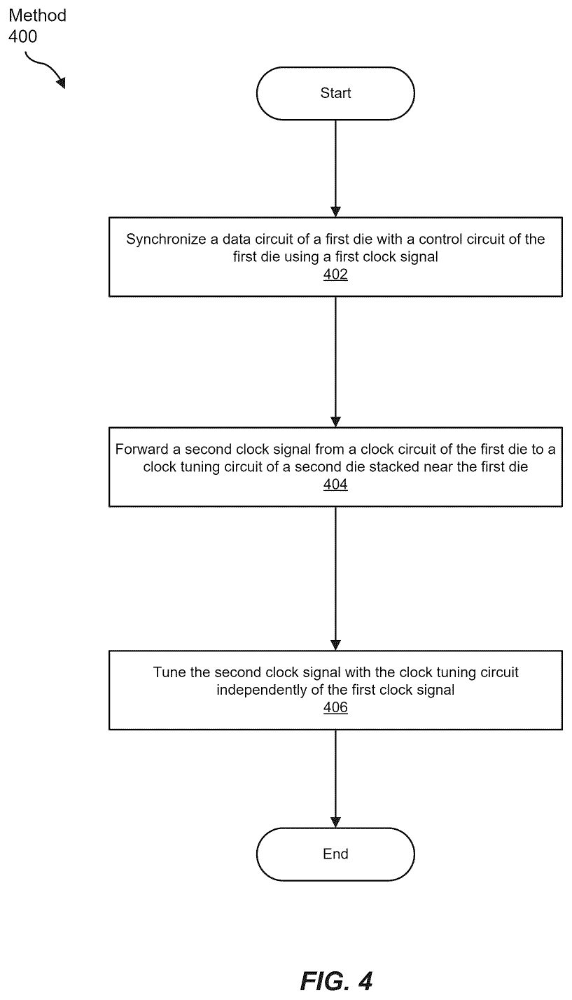

The following will provide, with reference to FIGS. 1-4, detailed descriptions of chiplet clock forwarding. Detailed descriptions of example systems and architectures will be provided in connection with FIGS. 1, 2A-2J, and 3A-3C. Detailed descriptions of corresponding methods will also be provided in connection with FIG. 4.

FIG. 1 is a block diagram of an example system 100 for chiplet clock forwarding. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor(s).

Further, in some implementations processor 110 can include or otherwise generally represent a co-processor that generally refers to any type or form of hardware-implemented processing unit capable of interpreting and/or executing computer-readable instructions, which in some examples works in conjunction with and/or based on instructions from a host/main processor such as a CPU, and further in some examples accesses and/or modifies one or more instructions stored in memory 120. Examples of co-processors include, without limitation, chiplets, microprocessors, microcontrollers, graphics processing units (GPUs), FPGAs that implement softcore processors, ASICs, SoCs, DSPs, NNEs, accelerators, portions of one or more of the same, variations or combinations of one or more of the same, and/or any other suitable physical processor.

As further illustrated in FIG. 1, processor 110 includes a control circuit 112, a clock circuit 114, a data circuit 116, and a clock tuning circuit 118. Control circuit 112 corresponds to circuitry and/or instructions for forwarding signals, such as data and/or clock signals, between dies/chiplets. Clock circuit 114 corresponds to circuitry (e.g., a clock generator circuit such as an oscillator) for generating a clock signal, such as a periodic clock signal of a desired frequency. In some examples, control circuit 112 can forward a clock signal from clock circuit 114, as will be described further below. Data circuit 116 corresponds to circuitry for holding and/or sending data signals, such as a flip-flop circuit, a latch circuit, etc., and/or logic circuits that can send/receive data in accordance with the clock signal. In some examples, data circuit 116 can include data and/or portions of data read from memory 120 (e.g., directly and/or indirectly via a cache or other circuit and further having been processed), and control circuit 112 can forward data from data circuit 116. Clock tuning circuit 118 corresponds to circuitry (e.g., a phase locked loop (PLL), a delay locked loop (DLL), a voltage controlled oscillator (VCO), a delay circuit, etc.) for tuning the clock signal, for instance by making the signal early or delayed, although in some implementations can further adjust other aspects of the clock signal, such as frequency, period, duty cycle, etc.

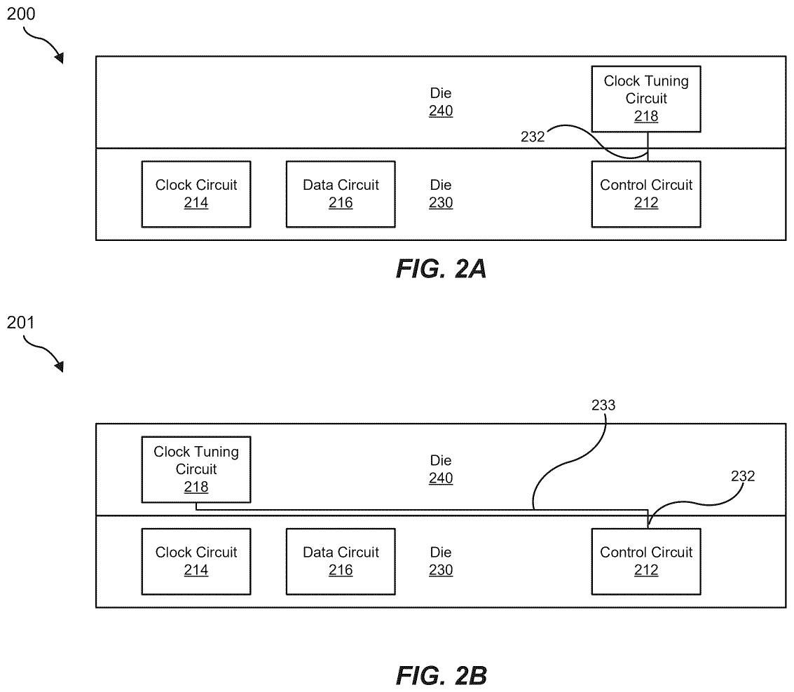

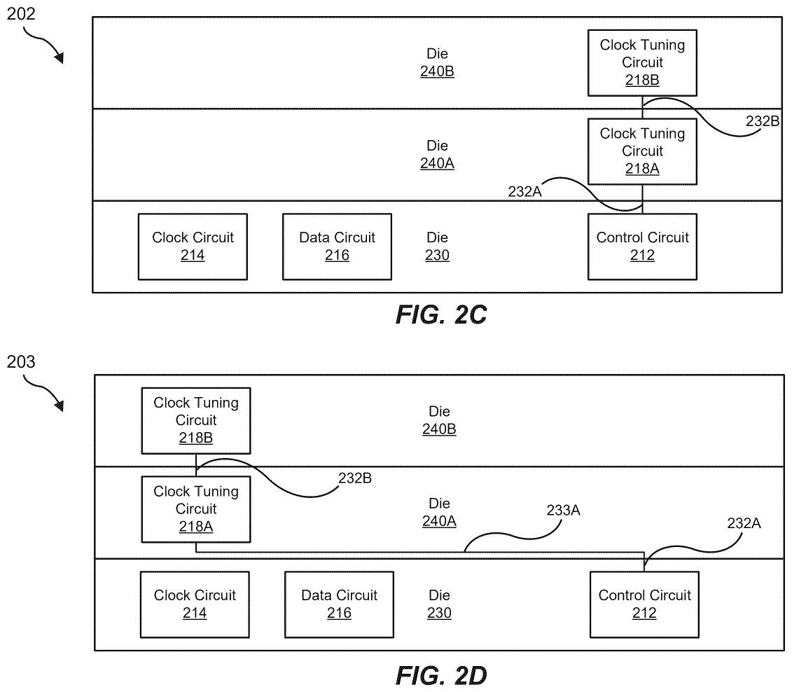

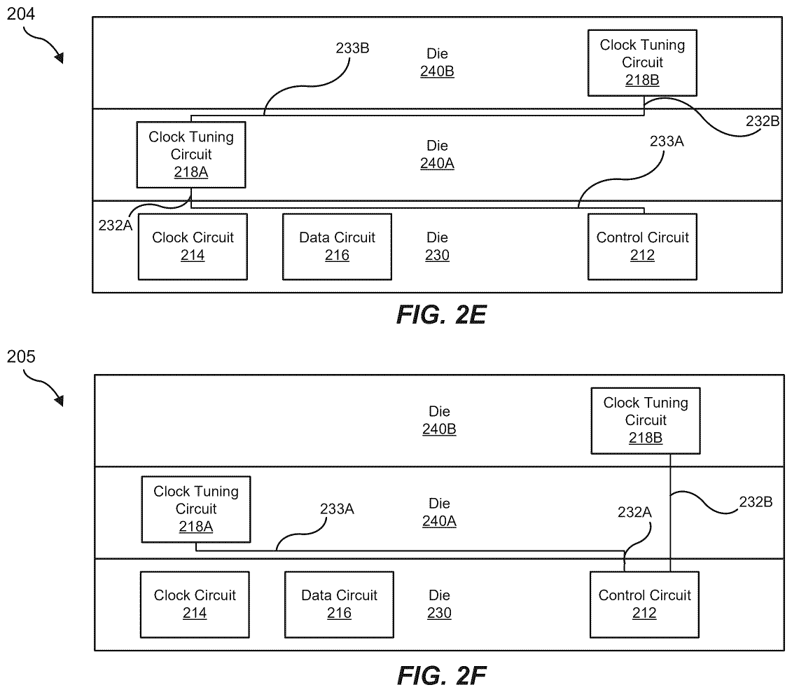

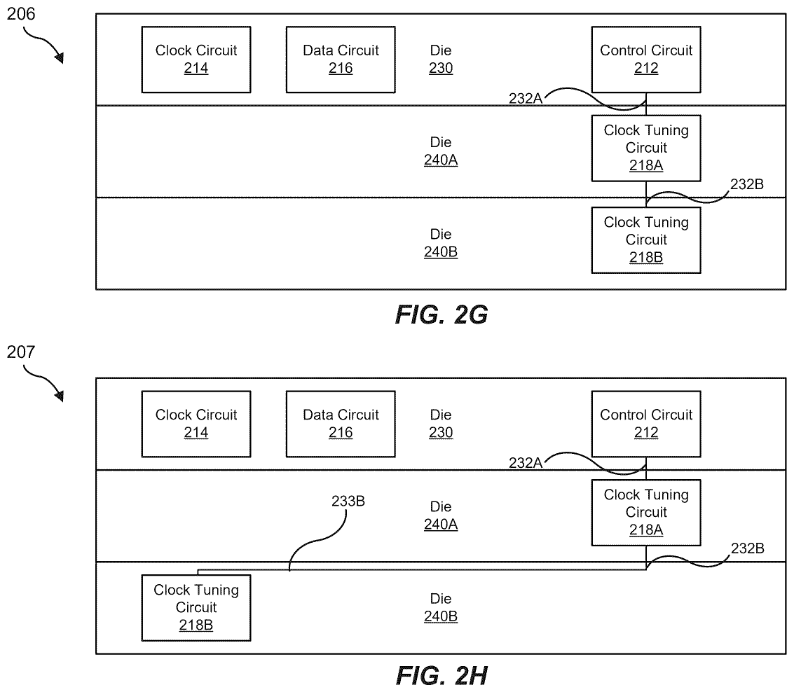

Although not illustrated in FIG. 1, processor 110 can include multiple chiplets/circuit blocks arranged as multiple stacked dies. FIGS. 2A-2J illustrate various simplified examples of stacked dies (e.g., a simplified side view or cross-sectional view). For example, FIG. 2A illustrates a simplified side view of a device 200 corresponding to processor 110. As illustrated in FIG. 2A, a die 240 can be stacked over a die 230, with various interconnect and/or fill layers omitted for illustrative purposes. Die 230 can include a clock circuit 214 (corresponding to clock circuit 114), a data circuit 216 (corresponding to data circuit 116), and a control circuit 212 (corresponding to control circuit 112). Die 240 can include a clock tuning circuit 218 (corresponding to clock tuning circuit 118). Die 230 can be coupled to die 240 with a through-silicon via (TSV) 232, although in other implementations TSV 232 can correspond to any other interconnect and/or combination of interconnects between dies.

In some examples, clock circuit 214 can generate a clock signal used by components of die 230. For example, data circuit 216, which in some examples can correspond to multiple components/units, can send/receive data based on the clock signal (e.g., based on a rising and/or falling edge of the clock signal). This clock signal can be tuned/modified (e.g., shifting phase earlier or later/delaying, adjusting frequency, etc.) as needed to account for clock skew or divergence for the components of die 230 and/or other aspects of a clock distribution for die 230.

Although not specifically shown in FIG. 2A, die 230 can send data to die 240. For example, control circuit 212 can received data from data circuit 216 and forward the data to an appropriate component of die 240 (which in some examples can be clock tuning circuit 218) through an appropriate connection, such as TSV 232 or similar. In some implementations, control circuit 212 can include a buffer for holding data, and sending data based on the same modified clock signal used by data circuit 216 to be properly synchronized with data circuit 216. Control circuit 212 can further send data from the buffer to clock tuning circuit 218, which in some examples further corresponds to a circuit for receiving data and can include a buffer for holding data received from die 230 (e.g., as forwarded from control circuit 212).

In some examples, die 240 can rely on clock circuit 214 (of die 230) for a clock signal to synchronize circuits/components of die 240. However, die 240 can have different clock tuning requirements (e.g., based on differences in manufacturing of the dies, components/circuits therein, signal propagation delays when crossing die boundaries, etc.). Although the modified clock signal as used by control circuit 212 can also be forwarded to die 240, further tuning the modified clock signal can present issues (e.g., additional complexity for determining proper tuning with respect to die 230, accounting for the tuning from die 230, etc.), which can be exacerbated as the clock signal is forwarded from an intervening die having also tuned the clock signal. Accordingly, it can be advantageous for die 240 to independently (from die 230) tune the original clock signal from clock circuit 214.

In some implementations, control circuit 212 can forward another clock signal from clock circuit 214 to die 240 (e.g., to clock tuning circuit 218). More specifically, using another branch in a clock tree from clock circuit 214 (e.g., a branch stemming from or near a root of the clock tree such that the original clock signal is generally untuned or unmodified) that is directed to control circuit 212, clock circuit 214 can receive (e.g., via a second port different from a port for receiving the modified clock signal) the unmodified clock signal and forward the same through TSV 232 to clock tuning circuit 218. Clock tuning circuit 218 can accordingly tune the unmodified clock signal (as received from control circuit 212 via TSV 232) for synchronizing circuit/components of die 240 (not shown in FIGS. 2A-2D). In some examples, using the tuned second clock signal, clock tuning circuit 218 can forward data held in its buffer (e.g., as received from control circuit 212).

As further illustrated in FIG. 2A, clock tuning circuit 218 (e.g., a corresponding circuit block of die 240) can be generally aligned over control circuit 212 (e.g., a corresponding circuit block of die 230) such that control circuit 212 can forward the unmodified clock signal via TSV 232. In other implementations, the circuit blocks can be arranged differently and accordingly connected via additional interconnect structures. For example, FIG. 2B illustrates a device 201 (e.g., a variation of device 200) showing clock tuning circuit 218 not generally aligned over control circuit 212 such that control circuit 212 forwards the unmodified clock signal through TSV 232 and an interconnect 233 (e.g., a horizontal interconnect in an appropriate layer). In yet other examples, other variations of connections (e.g., TSV 232 and/or interconnect 233) can be used as needed.

In addition, multiple dies can receive the unmodified clock signal from clock circuit 214 for tuning independently from the other dies, as illustrated in FIGS. 2C-2J. FIG. 2C illustrates another example device 202 (e.g., a variation of device 200) having multiple dies stacked over die 230, such as a die 240A (e.g., an instance of die 240) and die 240B (e.g., a separate instance of die 240). As illustrated in FIG. 2C, control circuit 212 can forward the unmodified clock signal through a TSV 232A (e.g., an instance of TSV 232) to a clock tuning circuit 218A (e.g., an instance of clock tuning circuit 218 configured for die 240A). In some examples, clock tuning circuit 218A can also forward the unmodified clock signal to die 240B (as will be explained further below), and more specifically to a clock tuning circuit 218B (e.g., a separate instance of clock tuning circuit 218 configured for die 240B) through a TSV 232B (e.g., a separate instance of TSV 232). Clock tuning circuit 218A can independently tune the unmodified clock signal and clock tuning circuit 218B can also independently tune the unmodified clock signal such that each die can tune its clock signal independently from other dies in the stack. As illustrated in FIG. 2C, clock tuning circuit 218B can be generally aligned over clock tuning circuit 218A such that clock tuning circuit 218A can forward the unmodified clock signal through TSV 232B. In other words, control circuit 212 and the circuit blocks receiving the unmodified clock signal (e.g., clock tuning circuit 218A and clock tuning circuit 218B) can be generally aligned such that TSVs (e.g., TSV 232A and TSV 232B) can be used for forwarding the unmodified clock signal.

FIG. 2D illustrates another example device 203 (e.g., a variation of device 200) in which clock tuning circuit 218A and clock tuning circuit 218B are not aligned over control circuit 212, although clock turning circuit 218A and clock tuning circuit 218B are generally aligned. Control circuit 212 can forward the unmodified clock signal through TSV 232A and an interconnect 233A (e.g., an instance of interconnect 233), whereas clock tuning circuit 218A can forward the unmodified clock signal to clock tuning circuit 218B through TSV 232B such that TSVs can be used when circuit blocks are generally aligned, and horizontal interconnects also used (in any appropriate arrangement/combination with TSVs) as needed when circuit blocks are not aligned.

FIG. 2E illustrates another example device 204 (e.g., a variation of device 200) in which control circuit 212 forwards the unmodified clock signal through interconnect 233A and TSV 232A, and clock tuning circuit 218A (not being aligned with either control circuit 212 or clock tuning circuit 218B) forwarding the unmodified clock signal to clock tuning circuit 218B through an interconnect 233B (e.g., a separate instance of interconnect 233) and TSV 232B. FIG. 2F illustrates yet another example device 205 (e.g., a variation of device 200). In FIG. 2F, control circuit 212 can forward the unmodified clock signal to clock tuning circuit 218A (e.g., through TSV 232A and interconnect 233A), and also to clock tuning circuit 218B through TSV 232B. In other words, in some examples, control circuit 212 can forward the unmodified clock signal directly and/or indirectly (e.g., though a clock tuning circuit of an intervening die).

In further examples, different die stacking configurations can be used. For example, FIG. 2G illustrates an example device 206 (e.g., a variation of device 200) and FIG. 2H illustrates another example device 207 (e.g., a variation of device 200) in which die 230 (e.g., the die including clock circuit 214) can be a top die or otherwise stacked over other dies. As illustrated in FIG. 2G, when the clock tuning circuits (e.g., clock tuning circuit 218A and clock tuning circuit 218B) are generally aligned with control circuit 212, control circuit 212 can forward the unmodified clock signal through TSVs (e.g., TSV 232A and TSV 232B, respectively). Alternatively, if a circuit block is not aligned (e.g., clock tuning circuit 218B in FIG. 2H), other appropriate connections can also be used (e.g., interconnect 233B).

In yet further examples, FIG. 2I illustrates another example device 208 (e.g., a variation of device 200) and FIG. 2J illustrates another example device 209 (e.g., a variation of device 200) in which die 230 (e.g., the die including clock circuit 214) can be stacked/sandwiched between other dies. As illustrated in FIG. 2I, when the clock tuning circuits (e.g., clock tuning circuit 218A and clock tuning circuit 218B) are generally aligned with control circuit 212, control circuit 212 can forward the unmodified clock signal through TSVs (e.g., TSV 232A and TSV 232B, respectively). Alternatively, if a circuit block is not aligned (e.g., clock tuning circuit 218A and clock tuning circuit 218B in FIG. 2J), other appropriate connections can also be used (e.g., interconnect 233A and interconnect 233B, respectively). Moreover, although FIG. 2A-2J illustrate two or three dies, the examples described can be combined in any configuration for stacking more than three dies, with connections and/or component locations appropriately modified as needed.

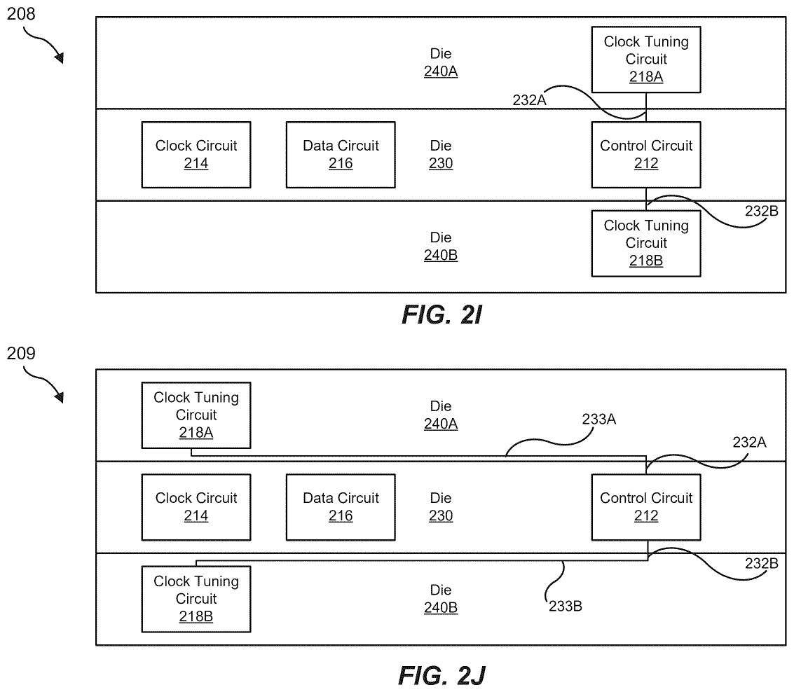

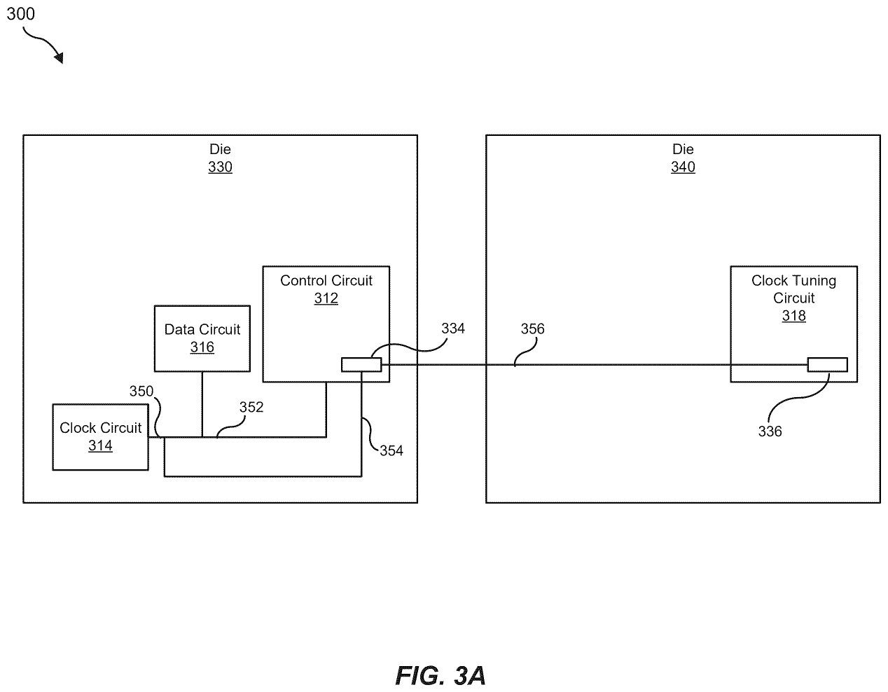

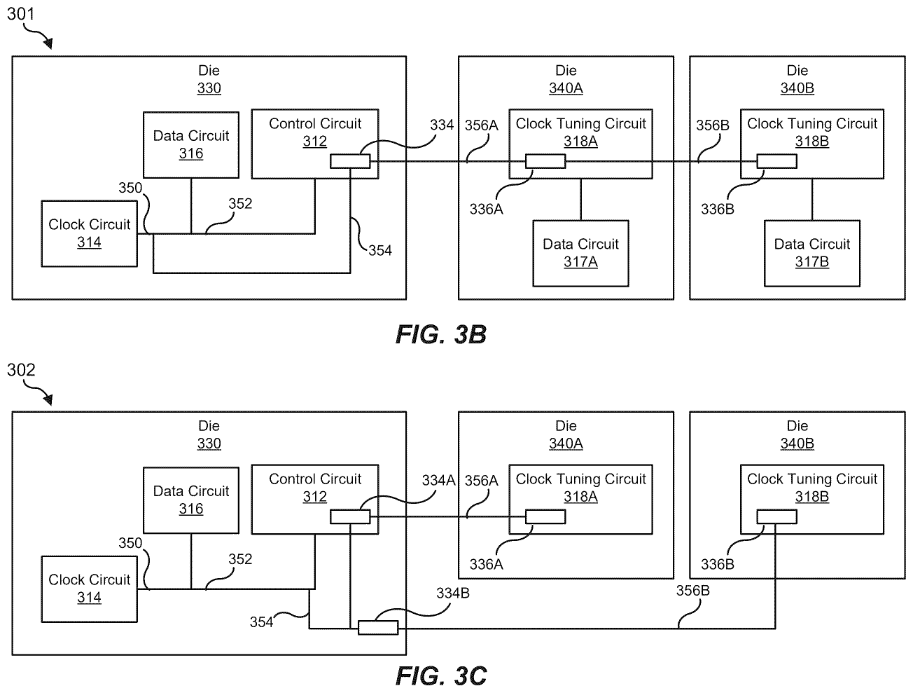

FIG. 3A illustrates a simplified diagram of a device 300 (corresponding to processor 110) including a die 330 (corresponding to die 230) and a die 340 (corresponding to die 240). Die 330 includes a clock circuit 314 (corresponding to clock circuit 114), a data circuit 316 (corresponding to data circuit 116), and a control circuit 312 (corresponding to control circuit 112). Die 340 includes a clock tuning circuit 318 (corresponding to clock tuning circuit 118). For illustrative purposes, die 330 and die 340 are illustrated side-by-side (e.g., using simplified top-down views of the dies), although would be in a stacked configuration (see, e.g., FIGS. 2A-2J).

As illustrated in FIG. 3A, a clock tree 350 can propagate a clock signal generated by clock circuit 314. A first branch 352 can propagate a first clock signal (e.g., tuned for a clock distribution corresponding to clock tree 350) to components/circuit blocks of die 330 (e.g., data circuit 316 and/or control circuit 312). In examples, control circuit 312 can include a first port for the first signal. A second branch 354 can propagate a second clock signal (e.g., a clock signal for forwarding, which can be untuned with respect to the clock distribution for clock tree 350) to control circuit 312, and more specifically to a second port in control circuit 312, to a macro 334 (e.g., a TSV macro corresponding to circuitry for sending signals through a TSV) and on to die 340, although in other examples macro 334 can correspond to and/or include other macros, ports, etc. for interfacing and sending signals. Control circuit 312 can forward the second clock signal through macro 334 and further through an interconnect 356 (e.g., corresponding to TSV 232 and/or interconnect 233) to clock tuning circuit 318, and more specifically received by a macro 336 corresponding to a bond-path via (BPV) (e.g., a via that can extend partially through a die/layer) macro, although in other examples can correspond to and/or include another macro, port, etc.

As also illustrated in FIG. 3A, second branch 354 can be an independent branch (e.g., independent from first branch 352) such that the second clock signal can be an unmodified clock signal direct or significantly direct (e.g., without any circuits/components for tuning the clock signal) from clock circuit 314. Further, a branching point of second branch 354 can be closer to a root of clock tree 350 than to control circuit 312 (e.g., macro 334), although in other implementations, second branch 354 the branching point can be closer to control circuit 312 (e.g., macro 334) than the root as needed (see, e.g., FIG. 3C). In addition, although FIG. 3A illustrates macro 334 in control circuit 312, in other implementations, macro 334 can be located elsewhere, which can further correspond to (e.g., align with) a location of macro 336, which can also be located elsewhere with respect to clock tuning circuit 318.

FIGS. 3B-3C illustrate variations of device 300 having multiple dies being forwarded the clock signal (e.g., corresponding to FIGS. 2C-2J) and shown with side-by-side dies for illustrative purposes. FIG. 3B illustrates a device 301 (corresponding to processor 110 and FIGS. 2C, 2D, 2E, 2G, and/or 2H) including die 330, a die 340A (e.g., corresponding to an iteration of die 340), and a die 340B (e.g., corresponding to a separate iteration of die 340). As illustrated in FIG. 3B, die 340A includes a clock tuning circuit 318A (e.g., corresponding to an iteration of clock tuning circuit 318), a data circuit 317A (e.g., corresponding to an iteration of a data circuit for die 340A similar to data circuit 316), a macro 336A (e.g., corresponding to an iteration of macro 336), and an interconnect 356A (e.g., corresponding to an iteration of interconnect 356). Die 340B includes a clock tuning circuit 318B (e.g., corresponding to a separate iteration of clock tuning circuit 318), a data circuit 317B (e.g., corresponding to a separate iteration of a data circuit for die 340B similar to data circuit 316), a macro 336B (e.g., corresponding to a separate iteration of macro 336), and an interconnect 356B (e.g., corresponding to a separate iteration of interconnect 356).

As illustrated in FIG. 3B, control circuit 312 of die 330 can forward the second clock signal from clock circuit 314 and second branch 354, through macro 334 and interconnect 356A, to clock tuning circuit 318A of die 340A via macro 336A. Clock tuning circuit 318A can independently tune (e.g., independent from die 330) the received unmodified clock signal for synchronizing with data circuit 317A (e.g., synchronizing data received from die 330 from control circuit 312 through clock tuning circuit 318A). Clock tuning circuit 318A can further forward the unmodified clock signal to macro 336B of clock tuning circuit 318B through interconnect 356B. Clock tuning circuit 318B can independently tune (e.g., independent from die 330 and/or die 340A) the received unmodified clock signal for synchronizing with data circuit 317B (e.g., synchronizing data received from die 340A and/or die 330). Moreover, although FIG. 3B illustrates a simplified architecture of macro 336A forwarding the unmodified clock signal to macro 336B, in other illustrations, additional branches (e.g., without clock tuning circuits/components) and/or TSV macros can further branch from macro 336A before connecting to interconnect 356B.

FIG. 3C illustrates a device 302 (corresponding to processor 110 and FIGS. 2F, 2I, and/or 2J) including die 330, die 340A, and die 340B. Die 330 can include a macro 334A (e.g., corresponding to an iteration of macro 334) and a macro 334B (e.g., corresponding to another macro that can be a TSV macro, BPV macro, etc.). In FIG. 3C, die 330 can forward the unmodified clock signal to both die 340A (e.g., via macro 334A) and die 340B (e.g., via macro 334B). Die 330 can include additional branches from second branch 354 as needed for connecting to macro 334A and/or macro 334B, such as second branch 354 splitting into separate branches in FIG. 3C, although in other implementations, other configurations can be used (e.g., a third branch from clock tree 350, different branch points, etc.).

In addition, macro 334A and/or macro 334B can be configured based on a die stack arrangement. For instance, macro 334B and/or interconnect 356B can correspond to an interconnect and/or TSV extending through die 340A (e.g., in a die stack arrangement similar to FIG. 2F). In another example, either of macro 334A or macro 334B can correspond to a TSV macro for connecting to a die stacked above, and the other corresponding to a BPV macro for connecting to a die stacked below (e.g., in a die stack arrangement similar to FIGS. 21 and/or 2J). Moreover, although FIG. 3A-3C illustrate two or three dies, the examples described can be combined in any configuration for stacking more than three dies, with connections and/or component locations appropriately modified as needed.

FIG. 4 is a flow diagram of an exemplary computer-implemented method 400 for chiplet clock forwarding. The steps shown in FIG. 4 can be performed by any suitable computer-executable code and/or computing system, including the system(s) illustrated in FIGS. 1, 2A-2J, and/or 3A-3C. In one example, each of the steps shown in FIG. 4 represent an algorithm whose structure includes and/or is represented by multiple sub-steps, examples of which will be provided in greater detail below.

As illustrated in FIG. 4, at step 402 one or more of the systems described herein synchronize a data circuit of a first die with a control circuit of the first die using a first clock signal. For example, control circuit 112 can synchronize with data circuit 116 using a first clock signal from clock circuit 114.

The systems described herein can perform step 402 in a variety of ways. In one example (e.g., in FIG. 2A), data circuit 216 and control circuit 212 can be synchronized using a clock signal from clock circuit 214. In another example (e.g. in FIG. 3A), clock tree 350 can distribute a tuned clock signal (e.g., tuned for die 330) to data circuit 316 and to control circuit 312 such that data signals therebetween can be coordinated (e.g., synchronized to the tuned clock signal).

Returning to FIG. 4, at step 404 one or more of the systems described herein forward a second clock signal from a clock circuit of the first die to a clock tuning circuit of a second die stacked near the first die. For example, control circuit 112 can forward a second clock signal from clock circuit 114.

The systems described herein can perform step 404 in a variety of ways. In one example, the second clock signal corresponds to an unmodified clock signal from a branch directly from the clock circuit. For instance, as illustrated in FIG. 3A, the second clock signal can be an unmodified clock signal from second branch 354 directly from (e.g., without passing through tuning circuits) clock circuit 314. Moreover, in some examples, the second die can be stacked over the first die (e.g., FIGS. 2A-2F, and 2I-2J) or under the first die (e.g., FIGS. 2G-2H).

At step 406 one or more of the systems described herein tune the second clock signal with the clock tuning circuit independently of the first clock signal. For example, clock tuning circuit 118 can tune the second clock signal independently of the first clock signal.

The systems described herein can perform step 406 in a variety of ways. In one example (e.g., FIG. 2A), clock tuning circuit 218 can tune the second clock signal (as forwarded from die 230) independently from the first clock signal tuned for die 230. For instance, die 230 (e.g., control circuit 212) does not forward any tuning parameters nor does clock tuning circuit 218 require any calibration with respect to die 230.

In another example (e.g., FIG. 3A), clock tuning circuit 318 can tune the second clock signal (as forwarded from die 330) independently from the first clock signal tuned for die 330 (e.g., tuned with respect to clock tree 350 and/or clock distribution of die 330). Although not shown in FIG. 3A, clock tuning circuit 318 can accordingly tune the second clock signal for a clock distribution (e.g., clock tree including drivers and other circuits for propagating the clock signal) of die 340. As described herein, tuning the second clock signal can include making the clock signal early or delayed (e.g., phase shifting) as well as other changes to the clock signal (e.g., frequency, duty cycle, amplitude, etc.) without having to calibrate for and/or receive clock tuning information from die 330.

In addition, in some examples, method 400 can also include forwarding the second clock signal to a second clock tuning circuit of a third die stacked in any arrangement with respect to the first and second dies (see, e.g., FIGS. 2C-2J, and 3B-3C). In some examples, the second die can forward the second clock signal to the third die (e.g., clock tuning circuit 218A to clock tuning circuit 218B as in FIGS. 2C, 2D, 2E, 2G, and/or 2H, and clock tuning circuit 318A to clock tuning circuit 318B in FIG. 3B). In other examples, the first die can forward the second clock signal to the third die (e.g., control circuit 212 to clock tuning circuit 218B in FIGS. 2F, 2I, and/or 2J, and control circuit 312 to clock tuning circuit 318B in FIG. 3C). Moreover, the second clock tuning circuit can tune the second clock signal independently of the first die and the second die such that the third die can tune the second signal independently from the second die tuning the second signal. In other words, each die can independently tune clock signals generated from a common clock source.

As detailed above, the systems and methods described herein provide the ability to tune a clock insertion delay (e.g., early or delay the clock) of individual chips/chiplets in a 3D stacked chiplet architecture for a clock signal that is forwarded from one die to another die with minimum (e.g., 2-stage) clock divergence. The stacked die configuration can, in some examples, restrict timing fixes in a data path due to abutment of stacked neighbor dies. In some examples, as described above, a TSV block (e.g., control circuit 112, control circuit 212, and/or control circuit 312) in a parent die (e.g., die generating a clock signal) can have two ports, a first port for a first clock signal as used by other components/circuits of the die, and a second port for receiving a second clock signal to be forwarded (e.g., a forwarded clock signal). Each chip's clock insertion delay can be controlled independently without having a dependency on other chips in the stack.

In some examples, the forwarded clock signal is not used in the parent die. In some implementations, the forwarded clock signal can be branched prior to use in the parent die (e.g., such as the first clock signal) and connected to the second port, allowing the forwarded clock signal to be forwarded to another die to tune independently of a clock distribution of the parent die. Additionally delays due to, for example, BPV and/or TSV macros in a path of the forwarded clock signal can be absorbed by local die clock tuning. Accordingly, local clock distribution within circuit blocks can be balanced between chiplets, and further, top level clock distribution can also be balanced between chiplets.

As detailed above, the computing devices and systems described and/or illustrated herein broadly represent any type or form of computing device or system capable of executing computer-readable instructions, such as those contained within the code/firmware/programs described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the instructions and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more instructions stored in the above-described memory device. Examples of physical processors include, without limitation, chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor.

In some examples, the term “physical processor” also refers to and/or includes a co-processor that generally refers to any type or form of hardware-implemented processing unit capable of interpreting and/or executing computer-readable instructions, which in some examples works in conjunction with and/or based on instructions from a host/main processor such as a CPU, and further in some examples accesses and/or modifies one or more instructions stored in the above-described memory device. Examples of co-processors include, without limitation, chiplets, microprocessors, microcontrollers, graphics processing units (GPUs), FPGAs that implement softcore processors, ASICs, SoCs, DSPs, NNEs, accelerators, portions of one or more of the same, variations or combinations of one or more of the same, and/or any other suitable physical processor.

Although described as separate elements/steps, the instructions described and/or illustrated herein can represent portions of a single program or application, including instructions implemented in code, firmware, one or more circuits, etc. In addition, in certain implementations one or more of these instructions can represent one or more software applications or programs that, when executed by a computing device, cause the computing device to perform one or more tasks. For example, one or more of the instructions described and/or illustrated herein represent instructions stored and configured to run on one or more of the computing devices or systems described and/or illustrated herein. In some implementations, one or more instructions can be implemented as a circuit or circuitry, including as part of a firmware, a ROM, one or more logic units, etc. One or more of these instructions can also represent or otherwise be implemented with all or portions of one or more special-purpose computers configured to perform one or more tasks.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a first die comprising a control circuit; and
a second die stacked over the first die;
wherein the control circuit configured to:
forward data to the second die based on a first clock signal; and
forward a second clock signal to the second die.

2. The device of claim 1, wherein the second die further comprises a clock tuning circuit for tuning the second clock signal for a data circuit of the second die.

3. The device of claim 2, wherein the clock tuning circuit tunes the second clock signal independently from the first clock signal.

4. The device of claim 1, wherein the control circuit receives the second clock signal directly from a clock circuit of the first die via an independent branch of a clock tree of the first die.

5. The device of claim 4, wherein a branching point of the independent branch is closer to a root of the clock tree than the control circuit.

6. The device of claim 4, wherein a branching point of the independent branch is closer to the control circuit than a root of the clock tree.

7. The device of claim 1, wherein the control circuit uses the first clock signal to synchronize with a data circuit of the first die.

8. The device of claim 1, further comprising a third die stacked over the second die, wherein the second die comprises a second control circuit configured to forward the second clock signal to the third die.

9. The device of claim 8, wherein the third die further comprises a clock tuning circuit for tuning the second clock signal.

10. The device of claim 9, wherein the clock tuning circuit tunes the second clock signal independently from the first die and the second die.

11. The device of claim 1, wherein the control circuit forwards the second clock signal using a through-silicon via (TSV).

12. A system comprising:
a memory; and
a processor comprising:
a first die comprising:
a clock circuit;
a data circuit for holding data from the memory; and
a control circuit that synchronizes with the data circuit based on a modified clock signal; and
a second die stacked over the first die;
wherein the control circuit configured to:
forward data from the data circuit to the second die; and
forward an unmodified clock signal from the clock circuit to the second die.

13. The system of claim 12, wherein the second die further comprises a clock tuning circuit for tuning the unmodified clock signal independently from the modified clock signal.

14. The system of claim 12, wherein the control circuit receives the unmodified clock signal directly from the clock circuit of the first die via an independent branch of a clock tree of the first die.

15. The system of claim 14, wherein a branching point of the independent branch is closer to a root of the clock tree than the control circuit.

16. The system of claim 14, wherein a branching point of the independent branch is closer to the control circuit than a root of the clock tree.

17. The system of claim 12, wherein:
the processor further comprises a third die stacked over the second die;
the second die comprises a second control circuit configured to forward the unmodified clock signal to the third die; and
the third die further comprises a clock tuning circuit for tuning the unmodified clock signal independently from the first die and the second die.

18. A method comprising:
synchronizing a data circuit of a first die with a control circuit of the first die using a first clock signal;
forwarding a second clock signal from a clock circuit of the first die to a clock tuning circuit of a second die stacked near the first die; and
tuning the second clock signal with the clock tuning circuit independently of the first clock signal.

19. The method of claim 18, further comprising:
forwarding the second clock signal to a second clock tuning circuit of a third die; and
tuning the second clock signal with the second clock tuning circuit independently of the first die and the second die.

20. The method of claim 18, wherein the second clock signal corresponds to an unmodified clock signal from a branch directly from the clock circuit.
